(19) United States
(12) Patent Application Publication
(10) Pub. No.: US 2021/0296704 A1
(43) Pub. Date: Sep. 23, 2021

(54) ALL SOLID STATE BATTERY AND METHOD FOR MANUFACTURING THE SAME

(71) Applicant: Panasonic Intellectual Property Management Co., Ltd., Osaka (JP)

(72) Inventors: KAZUHIRO MORIOKA, Osaka (JP); AKIRA KAWASE, Osaka (JP)

(21) Appl. No.: 17/341,456

(22) Filed: Jun. 8, 2021

Related U.S. Application Data
(63) Continuation of application No. PCT/JP2019/047353, filed on Dec. 4, 2019.

(30) Foreign Application Priority Data
Dec. 28, 2018 (JP) 2018-248597

(51) Int. Cl. H01M 10/0585; H01M 4/62; H01M 10/0525; H01M 50/193

(52) U.S. Cl. CPC H01M 10/0585; H01M 4/622; H01M 2300/0065; H01M 50/193; H01M 10/0525

(57) ABSTRACT

An all solid state includes: an electrode layer; a solid electrolyte layer containing a solid electrolyte; and a sealing layer containing a sealing material. At least one selected from the electrode layer and the solid electrolyte layer contains a binder, and a glass transition temperature of the sealing material is higher than a glass transition temperature of the binder.

### BACKGROUND

### 1. Technical Field

The present disclosure relates to an all solid state battery and a method for manufacturing the same.

### 2. Description of the Related Art

Japanese Unexamined Patent Application Publication Nos. 2017-73374 and 2012-38425 each have disclosed an all solid state battery including a sealing layer in contact with a battery element.

In a battery using a solid electrolyte, in order to suppress intrusion of moisture into the battery and/or in order to maintain the structure so as to prevent a short circuit caused by contact between collectors, a sealing layer may be provided in some cases.

In a related technique, a mechanical strength of a battery including a sealing layer is desired to be secured. In order to secure the mechanical strength of the battery, it is important to sufficiently secure a sealing strength by the sealing layer.

### SUMMARY

In one general aspect, the techniques disclosed here feature an all solid state battery comprising: an electrode layer; a solid electrolyte layer containing a solid electrolyte; and a sealing layer containing a sealing material. In the all solid state battery described above, at least one selected from the electrode layer and the solid electrolyte layer contains a binder, and a glass transition temperature of the sealing material is higher than a glass transition temperature of the binder.

According to the present disclosure, a sealing strength by the sealing layer can be sufficiently secured.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a schematic cross-sectional view of a battery according to one embodiment of the present disclosure;

FIG. 1B is a schematic cross-sectional view of a battery according to a modified example;

FIG. 2 is a flowchart showing one example of a method for manufacturing a battery;

FIG. 3 is an experimental photo of Sample 1; and

FIG. 4 is an experimental photo of Sample 2.

### DETAILED DESCRIPTION

In view of an increase in area, continuous production, and mass production of a battery, a coating process has been investigated to be applied to manufacturing of an all solid state battery. In the coating process, a slurry is prepared by dispersing a raw material powder in a solvent. Since the slurry is applied to a collector by a coating method, such as a screen printing method or a die coating method, a coating film is formed. By a thermal process using a drying furnace or the like, the solvent is evaporated from the coating film. Accordingly, an electrode plate including the collector and an electrode layer is obtained. In general, in order to impart a viscosity suitable for the coating process to the slurry, and/or in order to improve the strength of the electrode layer, a binder is added to the slurry.

As the binder, a thermoplastic resin has been used in many cases. Some thermoplastic resins have glass transition temperatures. When a predetermined load is applied to the thermoplastic resin, at a temperature higher than the glass transition temperature thereof, a plastic deformation behavior is shown, and at a temperature lower than the glass transition temperature thereof, an elastic deformation behavior is shown.

A slurry containing a solid electrolyte is applied on the electrode plate to form a coating film. The coating film is dried, so that a solid electrolyte layer is formed on the electrode plate. An electrode plate functioning as a positive electrode and an electrode plate functioning as a negative electrode are placed to face each other and are then pressed, so that an all solid state battery is obtained. In order to improve the performance of the battery, before the slurry containing a solid electrolyte is applied, the electrode plates may be pressed in some cases.

Through an intensive research carried out by the present inventors, it was first discovered that when a press temperature is lower than a glass transition temperature of a binder contained in at least one layer of the electrode layer or the solid electrolyte layer, warping is generated in the electrode plate. The reason the electrode plate is warped is believed as described below. While a press pressure is applied and maintained, particles (primarily of an active material and a solid electrolyte) forming the electrode layer are allowed to slightly move so as to fill voids formed therebetween. Accordingly, a filling rate of the electrode layer is increased. After a predetermined filling rate is achieved by a predetermined press pressure, an elongation of the electrode layer is primarily restricted in a direction orthogonal to a press direction. That is, since the elongation in the direction orthogonal to the press direction is generated in the electrode layer, in the electrode layer, a tensile stress is generated. On the other hand, in the collector in contact with the electrode layer, a compressive stress is generated. When the press temperature is lower than the glass transition temperature of the binder, if a load applied during the press is released, the binder contained in the electrode layer shows an elastic deformation behavior, and hence, the binder tends to recover its original shape and to return to its original position. As a result, due to the tensile stress of the electrode layer and the compressive stress of the collector, the electrode plate is warped. The positive electrode and the negative electrode are warped so that the positive electrode and the negative electrode come close to each other at a central portion of the battery and separate from each other at an outer peripheral portion of the battery. At the outer peripheral portion of the battery, the electrode plate is warped in a direction so that the collector separates from the sealing layer. As a result, a sealing strength by the sealing layer is decreased. As described above, in a related all solid state battery including a sealing layer, a problem in that the electrode layer is peeled away from the collector or the sealing strength by the sealing layer is insufficient may arise in some cases.

### (Guideline of Aspects of Present Disclosure)

A battery according to a first aspect of the present disclosure, includes:

an electrode layer;

a solid electrolyte layer containing a solid electrolyte; and

a sealing layer containing a sealing material,

at least one selected from the electrode layer and the solid electrolyte layer contains a binder, and

a glass transition temperature of the sealing material is higher than a glass transition temperature of the binder.

According to the first aspect, a battery in which a sealing strength by the sealing layer is sufficiently secured can be provided.

According to a second aspect of the present disclosure, for example, in the battery of the first aspect, the electrode layer and the solid electrolyte layer may be laminated to each other, and the sealing layer may be in contact with at least one selected from a side surface of the electrode layer and a side surface of the solid electrolyte layer. According to the structure as described above, the sealing strength by the sealing layer can be sufficiently secured.

According to a third aspect of the present disclosure, for example, in the battery of the first or the second aspect, the binder may contain a thermoplastic resin. The thermoplastic resin is softened when being heated to its glass transition temperature or more and pressed. Hence, when the binder contains a thermoplastic resin, a filling rate of the electrode layer and/or the solid electrolyte layer is increased. Furthermore, since the binder is softened, the electrode layer and/or the solid electrolyte layer can be easily formed, and hence a press time can be shortened.

According to a fourth aspect of the present disclosure, for example, in the battery of the third aspect, the thermoplastic resin may include at least one selected from a styrene-butadiene copolymer and a styrene-ethylene-butadiene copolymer. When at least one of the copolymers as described above is used for the binder, a preferable solubility to a solvent having a low polarity can be obtained.

According to a fifth aspect of the present disclosure, for example, in the battery of any one of the first to the fourth aspects, the glass transition temperature of the binder may be less than 120° C. In this temperature range, since the glass transition temperature of the binder is lower than a press temperature, warping of the electrode plate can be suppressed.

According to a sixth aspect of the present disclosure, for example, in the battery of any one of the first to the fifth aspects, the glass transition temperature of the sealing material may be 120° C. or more. In the temperature range described above, since the glass transition temperature of the sealing material is higher than the glass transition temperature of the binder, the sealing strength by the sealing layer can be maintained.

According to a seventh aspect of the present disclosure, for example, in the battery of any one of the first to the sixth aspects, the sealing material may contain a polyimide. Since a thermoplastic resin, such as a polyimide, having a high glass transition temperature is contained, even when the press temperature is high, the sealing strength by the sealing layer can be maintained.

According to an eighth aspect of the present disclosure, for example, in the battery of any one of the first to the seventh aspects, the electrode layer may contain an electrode active material and the solid electrolyte. Since the electrode active material and the solid electrolyte are contained, an electrode layer having a good efficiency can be formed.

A method for manufacturing a battery according to a ninth aspect of the present disclosure, includes:

heating at least one selected from an electrode layer and a solid electrolyte layer to a press temperature; and

pressing at least one selected from the electrode layer and the solid electrolyte layer at the press temperature,

at least one layer of the electrode layer or the solid electrolyte layer to be pressed at the press temperature contains a binder, and

the press temperature is higher than a glass transition temperature of the binder.

According to the ninth aspect of the present disclosure, the battery of the present disclosure can be efficiently manufactured.

According to a tenth aspect of the present disclosure, for example, the battery manufacturing method of the ninth aspect may further include: forming a sealing layer so as to be in contact with at least one selected from the electrode layer and the solid electrolyte layer, and when at least one selected from the electrode layer and the solid electrolyte layer is heated to the press temperature described above, the sealing layer may be heated to the press temperature, and when at least one selected from the electrode layer and the solid electrolyte layer is pressed, the sealing layer may be pressed at the press temperature. Since the sealing layer is provided, a mechanical strength of the battery can be secured. Furthermore, since the sealing layer is pressed at the press temperature, the sealing strength by the sealing layer can be maintained.

According to an eleventh aspect of the present disclosure, for example, in the battery manufacturing method of the tenth aspect, the sealing layer is formed from a sealing material having a glass transition temperature, and the glass transition temperature of the sealing material is higher than the glass transition temperature of the binder. When the glass transition temperature of the sealing material is higher than the glass transition temperature of the binder, since the sealing strength by the sealing layer can be maintained, the mechanical strength of the all solid state battery can be maintained.

According to a twelfth aspect of the present disclosure, for example, in the battery manufacturing method of the eleventh aspect, the glass transition temperature of the sealing material forming the sealing layer may be higher than the press temperature. When the glass transition temperature of the sealing material is higher than the press temperature, the sealing material is not plastic deformed. As a result, since the sealing strength by the sealing layer can be maintained, the mechanical strength of the all solid state battery can be maintained.

### EMBODIMENTS

Hereinafter, embodiments of the present disclosure will be described with reference to the drawings. The present disclosure is not limited to the following embodiments.

### [Structure of all Solid State Battery]

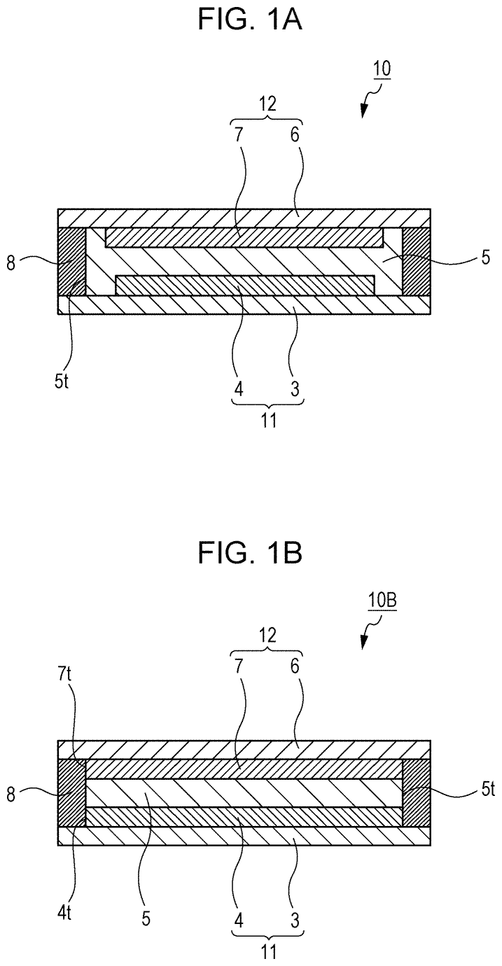

FIG. 1A is a schematic cross-sectional view of an all solid state battery 10 according to one embodiment. As shown in FIG. 1A, the all solid state battery 10 includes a positive electrode 11, a negative electrode 12, a solid electrolyte layer 5, and a sealing layer 8. The positive electrode 11 includes a positive electrode collector 3 and a positive electrode layer 4. The negative electrode 12 includes a negative electrode collector 6 and a negative electrode layer 7. On the positive electrode collector 3, the positive electrode layer 4 is disposed. On the negative electrode collector 6, the negative electrode layer 7 is disposed. The solid electrolyte layer 5 is disposed between the positive electrode layer 4 and the negative electrode layer 7. The solid electrolyte layer 5 is in contact with the positive electrode layer 4 and the negative electrode layer 7. The sealing layer 8 is in contact with the positive electrode collector 3 and the negative electrode collector 6. The positive electrode layer 4 and the negative electrode layer 7 are each an example of the electrode layer. The positive electrode 11 and the negative electrode 12 are each an example of the electrode plate. According to the sealing layer 8, intrusion of moisture into the all solid state battery 10 can be suppressed, and/or since the structure of the all solid state battery 10 is maintained, a short circuit caused by the contact between the positive electrode collector 3 and the negative electrode collector 6 can be prevented. As a result, a mechanical strength of the all solid state battery 10 can be secured.

When the all solid state battery 10 is plan viewed, the sealing layer 8 has a frame shape. The positive electrode layer 4, the solid electrolyte layer 5, and the negative electrode layer 7 are surrounded by the sealing layer 8. The positive electrode collector 3 is in contact with a bottom surface of the sealing layer 8, and the negative electrode collector 6 is in contact with a top surface of the sealing layer 8.

According to this embodiment, the sealing layer 8 is in contact with a side surface 5t of the solid electrolyte layer 5. According to the structure as described above, the sealing strength by the sealing layer 8 can be more sufficiently secured. The sealing layer 8 is not in contact with the positive electrode layer 4 and the negative electrode layer 7. According to the structure as described above, in the manufacturing of the all solid state battery 10, a sealing material and an electrode material are not likely to react with each other. That is, a risk of degradation in performance of the battery can be avoided. In the manufacturing of the all solid state battery, when the sealing material is impregnated in the electrode layer, an impregnated portion thereof cannot function as the electrode. As a result, the performance of the battery is degraded. In this embodiment, since the electrode layer is formed before the sealing layer 8 is formed, the problem as described above is not likely to be generated, and an area of the electrode which contributes to electric power generation can be easily defined. In addition, even when a large number of batteries are manufactured, the performance of the battery is not likely to be degraded.

FIG. 1B is a schematic cross-sectional view of an all solid state battery 10B according to a modified example. In the all solid state battery 10B of this modified example, a side surface 4t of a positive electrode layer 4, a side surface 7t of a negative electrode layer 7, and a side surface 5t of a solid electrolyte layer 5 are in contact with a sealing layer 8. According to the structure as described above, a sealing strength by the sealing layer 8 can be more sufficiently secured. In addition, since the volume of the solid electrolyte layer 5 can be decreased, reduction in manufacturing cost of the all solid state battery 10B can be expected by the reduction in material cost. The other components of the all solid state battery 10B are the same as those of the all solid state battery 10. The respective components of the all solid state battery 10 will be described in detail.

### (Positive Electrode 11 and Negative Electrode 12)

The positive electrode 11 includes the positive electrode collector 3 and the positive electrode layer 4. The negative electrode 12 includes the negative electrode collector 6 and the negative electrode layer 7.

Materials for the positive electrode collector 3 and the negative electrode collector 6 are not particularly limited, and in general, materials used for a lithium ion battery may be used. The material for the positive electrode collector 3 may be the same as or different from the material for the negative electrode collector 6. As the materials for the positive electrode collector 3 and the negative electrode collector 6, for example, there may be mentioned copper, a copper alloy, aluminum, an aluminum alloy, stainless steel, nickel, titanium, carbon, lithium, indium, or an electrically conductive resin. The shapes of the positive electrode collector 3 and the negative electrode collector 6 are also not particularly limited. As the shapes of the positive electrode collector 3 and the negative electrode collector 6, for example, there may be mentioned foil, a film, or a sheet. Irregularity may also be imparted to the surfaces of the positive electrode collector 3 and the negative electrode collector 6.

The electrode layer contains an active material. A composition of the active material is not particularly limited and may be selected in accordance with a required function. The electrode layer may contain, if needed, other materials, such as an electrically conductive material, a solid electrolyte, and a binder.

As the active materials, in general, a positive electrode active material and a negative electrode active material may be mentioned. In accordance with the required function, the positive electrode active material and the negative electrode active material are selected.

As the positive electrode active material, for example, there may be mentioned a lithium-containing transition metal oxide, a vanadium oxide, a chromium oxide, or a lithium-containing transition metal sulfide. As the lithium-containing transition metal oxide, for example, there may be mentioned LiCoO₂, LiNiO₂, LiMnO₂, LiMn₂O_{4,} LiNiCoMnO₂, LiNiCoO₂, LiCoMnO₂, LiNiMnO₂, LiNiCoMnO₄, LiMnNiO₄, LiMnCoO₄, LiNiCoAlO₂, LiNiPO₄, LiCoPO₄, LiMnPO₄, LiFePO₄, Li₂NiSiO₄, Li₂CoSiO₄, Li₂MnSiO₄, Li₂FeSiO₄, LiNiBO₃, LiCoBO₃, LiMnBO₃, or LiFeBO₃. As an example of the lithium-containing transition metal sulfide, for example, there may be mentioned LiTiS₂, Li₂TiS₃, or Li₃NbS₄. At least one of those positive electrode active materials may be used.

As the negative electrode active material, for example, there may be mentioned a carbon material, a lithium alloy, a metal oxide, lithium nitride (Li₃N), a lithium metal, or an indium metal. As the carbon material, for example, there may be mentioned artificial graphite, graphite, non-graphitizable carbon, or graphitizable carbon. As the lithium alloy, for example, an alloy between lithium and at least one metal selected from the group consisting of Al, Si, Pb, Sn, Zn, and Cd may be mentioned. As the metal oxide, for example, LiFe₂O₃, WO₂, MoO₂, SiO, or CuO may be mentioned. A mixture or a composite formed from a plurality of materials may also be used as the negative electrode active material.

The shapes of the positive electrode active material and the negative electrode active material are not particularly limited and may be, for example, in the form of particles. The sizes of the positive electrode active material and the negative electrode active material are also not particularly limited. When the positive electrode active material and the negative electrode active material are each in the form of particles, an average particle diameter of the particles of the positive electrode active material and an average particle diameter of the particles of the negative electrode active material may be larger than or equal to 0.5 μm and smaller than or equal to 20 μm or may also be larger than or equal to 1 μm and smaller than or equal to 15 μm. The average particle diameter may be, for example, a median diameter (d50) measured using a particle size distribution measurement device.

When the particle size distribution cannot be measured, the average particle diameter of the particles can be calculated by the following method. A particle swarm is observed by an electron microscope, and an area of a specific particle in an electron microscopic image is calculated by an image processing. When the particle swarm only cannot be direct-observed, a structure in which particles are contained is observed by an electron microscope, and an area of a specific particle in an electron microscopic image is calculated by an image processing. A diameter of a circle having an area equal to the area thus calculated is regarded as the diameter of the specific particle. The diameters of an arbitrary number of particles (for example, 10 particles) are calculated, and an average value obtained therefrom is regarded as the average particle diameter of the particles.

The electrically conductive material is not particularly limited and may be appropriately selected from materials which are generally used for a lithium ion battery. As the electrically conductive material, for example, there may be mentioned graphite, carbon black, electrically conductive fibers, an electrically conductive oxide, or an organic electrically conductive material. Those electrically conductive materials may be used alone, or at least two types thereof may be used in combination.

The solid electrolyte is not particularly limited and may be appropriately selected, in accordance with the type of active material and the application of the all solid state battery 10, from materials generally used for a lithium ion battery. As the solid electrolytes, for example, there may be mentioned a sulfide-based solid electrolyte material, an oxide-based solid electrolyte material, other inorganic solid electrolyte materials, and an organic solid electrolyte material. The solid electrolytes may be used alone, or at least two types thereof may be used in combination. The shape of the solid electrolyte is not particularly limited and may be, for example, in the form of particles. The size of the solid electrolyte is also not particularly limited. When the solid electrolyte is in the form of particles, an average particle diameter of the particles of the solid electrolyte may be larger than or equal to 0.01 μm and smaller than or equal to 15 μm and may also be larger than or equal to 0.2 μm and smaller than or equal to 10 μm. The average particle diameter may be, for example, a median diameter (d50) measured by a particle size distribution measurement device.

The binder is not particularly limited and may be appropriately selected from materials generally used for a lithium ion battery. As the binder, for example, a thermoplastic resin may be mentioned. As the thermoplastic resin, for example, a thermoplastic rubber, such as a styrene-butadiene copolymer or a styrene-ethylene-butadiene copolymer, may be mentioned. When a slurry is prepared, in order to prevent degradation in performance, such as ion conductivity, of the solid electrolyte, a solvent having a low polarity may be used in some cases. When a slurry is prepared, a styrene-butadiene copolymer or a styrene-ethylene-butadiene copolymer also shows a preferable solubility to a solvent having a low polarity. Hence, when the polymer as described above is used, the degradation in performance of the solid electrolyte can be prevented. As other examples of the thermoplastic resin, for example, there may be mentioned an ethyl cellulose, a poly(vinylidene fluoride), a polyethylene, a polypropylene, a polyisobutylene, a polystyrene, a poly(vinyl chloride), a poly(vinyl acetate), a poly(methyl methacrylate), a poly(ethyl methacrylate), a poly(n-propyl methacrylate), a poly(n-butyl methacrylate), a polydimethylsiloxane, cis-1,4-polybutadiene, a polyisoprene, nylon-6, nylon-6,6, a poly(ethylene terephthalate), and a poly(vinyl alcohol). Those binders may be used alone, or at least two types thereof may be used in combination.

A glass transition temperature of the binder is lower than a glass transition temperature of the sealing material which will be described below. The glass transition temperature of the binder may be 100° C. or more and may also be 120° C. or more. When the glass transition temperature of the binder is lower than the glass transition temperature of the sealing material, a press temperature can be set between the glass transition temperature of the binder and the glass transition temperature of the sealing material. That is, the press temperature is higher than the glass transition temperature of the binder and is lower than the glass transition temperature of the sealing material. When the difference in temperature is sufficiently large, since the press temperature can be easily set between the glass transition temperature of the binder and the glass transition temperature of the sealing material, a press step can be easily performed. The glass transition temperature may be measured, for example, using a thermal mechanical analysis (TMA), a dynamic viscoelasticity measurement (DMA), a differential scanning calorimetry (DSC), or a differential scanning calorimetry thermal analysis (DTA).

### (Solid Electrolyte Layer 5)

A material for the solid electrolyte layer 5 is not particularly limited and may be appropriately selected, in accordance with the type of active material and the application of the all solid state battery 10, from materials generally used for a lithium ion battery. As the materials for the solid electrolyte layer 5, for example, there may be mentioned a sulfide-based solid electrolyte material, an oxide-based solid electrolyte material, other inorganic solid electrolyte materials, and an organic solid electrolyte material. The solid electrolytes may be used alone, or at least two types thereof may be used in combination. The shape of the solid electrolyte is not particularly limited and may be, for example, in the form of particles. The size of the solid electrolyte is also not particularly limited. When the solid electrolyte is in the form of particles, an average particle diameter of the particles of the solid electrolyte may be larger than or equal to 0.01 μm and smaller than or equal to 15 μm and may also be larger than or equal to 0.2 μm and smaller than or equal to 10 μm. The average particle diameter may be, for example, a median diameter (d50) measured by a particle size distribution measurement device.

### (Sealing Layer 8)

As a sealing material forming the sealing layer 8, a thermoplastic resin having a high glass transition temperature may be used. As the thermoplastic resin having a high glass transition temperature, for example, a polyimide may be mentioned. When a polyimide is used, even in the case in which the press temperature is high, the sealing strength of the sealing layer 8 can be maintained. That is, since the range of the press temperature can be set at a high temperature side, the all solid state battery 10 can be efficiently manufactured. Furthermore, since the range of the glass transition temperature of the binder can also be set at a high temperature side, a larger number of types of binders may be used. As another example of the thermoplastic resin usable as the sealing material, for example, a poly(a-methylstyrene), a polycarbonate, or a polyacrylonitrile may be mentioned. Furthermore, a thermosetting resin or a photocurable resin may also be used as the sealing material. Those materials may be used alone, or at least two types thereof may be used in combination. When the glass transition temperature of the sealing material is sufficiently high, the sealing strength by the sealing layer can be sufficiently maintained.

In order to enhance the function of the sealing layer 8, the sealing material may also contain other materials, such as a functional powder and/or functional fibers. As the other materials, for example, an inorganic filler and a silica gel may be mentioned. The inorganic filler has a function to increase a structure maintaining force. The silica gel has a function to enhance a water resistance. Those functional powder and fibers may be used alone, or at least two types thereof may be used in combination.

The glass transition temperature of the sealing material is higher than the glass transition temperature of the binder described above. The glass transition temperature of the sealing material may be 120° C. or more. The difference in glass transition temperature between the sealing material and the binder is, for example, higher than or equal to 10° C. and lower than or equal to 60° C. When the glass transition temperature of the sealing material is higher than the glass transition temperature of the binder, the press temperature can be set between the glass transition temperature of the sealing material and the glass transition temperature of the binder. That is, the press temperature is higher than the glass transition temperature of the binder and is lower than the glass transition temperature of the sealing material. When the difference in temperature therebetween is sufficiently large, since the press temperature may be easily set at a temperature between the glass transition temperature of the binder and the glass transition temperature of the sealing material, the press step can be easily performed.

### [Method for Manufacturing All Solid State Battery]

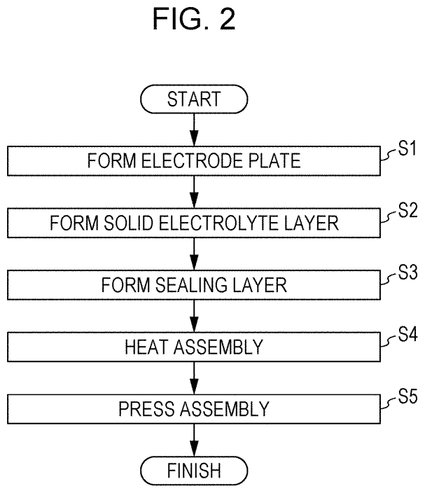

Next, one example of a method for manufacturing the all solid state battery 10 will be described. FIG. 2 shows a procedure of manufacturing of the all solid state battery 10.

First, in Step 51, the positive electrode 11 and the negative electrode 12 are formed. A mixture is prepared which contains a positive electrode active material or a negative electrode active material and also contains, if needed, other materials, such as an electrically conductive material, a solid electrolyte, and a binder. A mixing ratio of the materials may be appropriately determined in accordance with use application of the battery and the like. Subsequently, the mixture is mixed together by a mixing machine. The mixing machine is not particularly limited, and a known machine may be used. As the mixing machine, for example, a planetary mixer or a ball mill may be mentioned. However, a mixing method of the materials is not particularly limited.

Next, the mixture containing the active material is adhered on a collector to have a predetermined thickness. Accordingly, an electrode plate including the collector and an electrode layer is obtained.

Another method for forming an electrode plate is as follows. First, a mixture containing an active material is dispersed in an appropriate solvent to prepare a slurry. The slurry is applied on the positive electrode collector 3 or the negative electrode collector 6 to form a coating film. Subsequently, the coating film is dried, so that the electrode plate is formed. As a slurry coating method, for example, there may be mentioned a screen printing method, a die coating method, a spray method, or a doctor blade method.

Next, in Step S2, the solid electrolyte layer 5 is formed. A method for forming the solid electrolyte layer 5 is not particularly limited, and a known method may be used. First, a mixture containing a solid electrolyte, a binder, and the like is prepared. A mixing ratio of the materials is appropriately determined in accordance with use application of the all solid state battery 10 and the like. Subsequently, the mixture is mixed together by a mixing machine. The mixing machine is not particularly limited, and a known machine may be used. As the mixing machine, for example, a planetary mixer or a ball mill may be mentioned. However, a mixing method of the materials is not particularly limited.

The mixture containing a solid electrolyte is adhered on the positive electrode layer 4 or the negative electrode layer 7 to have a predetermined thickness. Accordingly, the solid electrolyte layer 5 is formed.

Another method for forming the solid electrolyte layer 5 is as follows. First, a mixture containing a solid electrolyte is dispersed in an appropriate solvent to prepare a slurry. The slurry is applied on the positive electrode layer 4 or the negative electrode layer 7 to form a coating film. Subsequently, the coating film is dried, so that the solid electrolyte layer 5 is formed. As a slurry coating method, for example, there may be mentioned a screen printing method, a die coating method, a spray method, or a doctor blade method.

Still another method for forming the solid electrolyte layer 5 is as follows. The slurry described above is applied on a support member to form a coating film. Subsequently, the coating film is dried, so that a solid electrolyte sheet is obtained. The solid electrolyte sheet thus obtained is transferred from the support member to the positive electrode 11 or the negative electrode 12, so that the solid electrolyte layer 5 disposed on the positive electrode 11 or the negative electrode 12 can be formed.

The binder may be contained in at least one selected from the group consisting of the positive electrode layer 4, negative electrode layer 7, and the solid electrolyte layer 5. The binder may also be contained in all of the positive electrode layer 4, negative electrode layer 7, and the solid electrolyte layer 5. A composition of the binder contained in the positive electrode layer 4 may be the same as or different from a composition of the binder contained in the solid electrolyte layer 5. A composition of the binder contained in the negative electrode layer 7 may be the same as or different from the composition of the binder contained in the solid electrolyte layer 5. The composition of the binder contained in the positive electrode layer 4 may be the same as or different from the composition of the binder contained in the negative electrode layer 7.

Subsequently, in Step S3, the sealing layer 8 is formed. A method for forming the sealing layer 8 is not particularly limited, and a known method may be used. For example, a sealing material is applied to the electrode plate so as to be in contact with at least one selected from the electrode layer and the solid electrolyte layer 5. The sealing material may also be in contact with at least one selected from the positive electrode collector 3 and the negative electrode collector 6. As a coating method of the sealing material, for example, a screen printing method, an ink jet method, or a coating method using a dispenser may be mentioned. If needed, the sealing material is dried, so that the sealing layer 8 is formed.

Next, the positive electrode 11 and the negative electrode 12 are laminated so as to obtain an assembly including the positive electrode 11, the solid electrolyte layer 5, the negative electrode 12, and the sealing layer 8. The positive electrode layer 4 is disposed on the positive electrode collector 3, and the negative electrode layer 7 is disposed on the negative electrode collector 6. The solid electrolyte layer 5 is disposed between the positive electrode layer 4 and the negative electrode layer 7.

Subsequently, in Step S4, at least one layer of the electrode layer or the solid electrolyte layer 5 is heated to a press temperature. In this embodiment, for example, when a flat plate press machine is used, a plate in contact with the assembly during pressure application is heated, so that the assembly can be heated to the press temperature. When a roll press machine is used, by heating a roller, the assembly can also be heated to the press temperature.

Next, in Step S5, at least one layer of the electrode layer or the solid electrolyte layer 5 is pressed at the press temperature. In particular, the assembly is pressed so that a load is applied to a thickness direction of each layer. In this step, at least one layer of the electrode layer or the solid electrolyte layer 5 contains the binder, and the layer containing the binder is pressed at the press temperature. In addition, the press temperature is higher than the glass transition temperature of the binder. Since the press is performed during heating, filling rates of the active material and the solid electrolyte are increased, and a contact interface area between particles of the active material and particles of the solid electrolyte is increased. As a result, the performance of the all solid state battery 10 is improved. The “electrode layer” is at least one selected from the positive electrode layer 4 and the negative electrode layer 7.

After the electrode layer and the solid electrolyte layer 5 are separately heated to the press temperature, and the assembly is then formed, the assembly may be heated and pressed so as to obtain the all solid state battery 10.

The press temperature is specified, for example, by a surface temperature of the collector. However, when a heat capacity of the plate or a heat capacity of the roller is sufficiently large as compared to a heat capacity of an object, the press temperature may be, for example, a surface temperature of the plate or a surface temperature of the roller. “To press at a press temperature” indicates that while being maintained at a press temperature, the object is pressed.

In this embodiment, when the assembly is heated to the press temperature, the sealing layer 8 is also heated to the press temperature. When the assembly is pressed at the press temperature, the sealing layer 8 is also pressed at the press temperature. In particular, the entire assembly can be pressed at the press temperature so that the load is applied in a thickness direction of each layer. Hence, the all solid state battery 10 can be easily manufactured. Furthermore, since the sealing layer 8 is heated to the press temperature and then pressed, the sealing strength by the sealing layer 8 can be maintained. As a result, the performance of the all solid state battery 10 is improved.

Through the steps described above, the all solid state battery 10 is obtained.

In the case in which the press temperature is lower than the glass transition temperature of the binder, when the electrode layer and/or the solid electrolyte layer is pressed, the binder is elastic deformed. When the binder dispersively present in grain boundaries of particles of the electrode active material and particles of the solid electrolyte is elastic deformed, a part of the load by the press deforms the electrode layer and/or the solid electrolyte layer in a direction orthogonal to the press direction. When the load by the press is released, the binder tends to recover its original shape and to return to its original position. As a result, the electrode plate is warped. In the case in which the electrode layer is located at an upper side, and the collector is located at a lower side, the electrode plate is warped to have an upward convex shape. In addition, in the case in which the electrode layer is located at a lower side, and the collector is located at an upper side, the electrode plate is warped to have a downward convex shape. Since the positive electrode layer and the negative electrode layer face each other, the positive electrode and the negative electrode warp so that at a central portion of the battery, the positive electrode and the negative electrode come close to each other, and at an outer peripheral portion of the battery, the positive electrode and the negative electrode separate from each other. Hence, the distance between an end portion of the positive electrode collector and an end portion of the negative electrode collector is increased, and as a result, the sealing strength by the sealing layer is decreased.

Furthermore, when the warping of the electrode plate is large, cracks may be generated between the electrode layer and the collector, and/or the electrode layer may be peeled away from the collector in some cases. In the case described above, the performance of the battery may be degraded in some cases.

On the other hand, in this embodiment, the press temperature is higher than the glass transition temperature of the binder. Hence, when the press is performed at the press temperature, the binder is plastic deformed. The binder dispersively present in the grain boundaries of the particles of the electrode active material and the particles of the solid electrolyte functions so as to decrease voids formed between the particles. As a result, the binder is plastic deformed. That is, the elongation is generated in the electrode layer in a direction orthogonal to the press direction, and in association with this elongation, the binder is plastic deformed. Hence, even when the load by the press is released, the contraction in the direction orthogonal to the press direction can be sufficiently suppressed. Since the sealing layer 8 is not pulled away from the end portion of the positive electrode collector 3 and the end portion of the negative electrode collector 6, the sealing strength can be maintained.

When the press temperature is higher than the glass transition temperature of the binder, the binder shows a plastic deformation behavior. Although the binder is deformed along the direction of deformation of the electrode layer generated by the press, even when the load by the press is released, a stress to recover the original shape is relaxed. That is, the tensile stress of the electrode layer is relaxed. As a result, since the warping of the electrode plate is significantly suppressed, the sealing strength can be maintained.

The difference between the press temperature and the glass transition temperature of the binder is, for example, higher than or equal to 0° C. and lower than or equal to 40° C. In the case in which the press temperature is higher than the glass transition temperature of the binder, since the binder is sufficiently plastic deformed when the press is performed, the deformation of the electrode layer and/or the solid electrolyte layer 5 thus pressed can be suppressed. That is, since the warping of the electrode plate can be suppressed, the sealing layer 8 is not likely to be peeled away from the collector. Since the sealing strength by the sealing layer 8 is sufficiently secured, an all solid state battery 10 having a high mechanical strength can be provided.

The glass transition temperature of the sealing material is, for example, higher than the glass transition temperature of the binder. In this case, the press temperature may be higher than the glass transition temperature of the sealing material. In the case in which the press temperature is higher than the glass transition temperature of the sealing material, when the press is performed at the press temperature, the sealing material is plastic deformed. However, when the difference between the glass transition temperature of the sealing material and the glass transition temperature of the binder is large, the plastic deformation of the sealing material is suppressed compared to that of the binder. As a result, since the sealing strength by the sealing layer 8 is sufficiently secured, an all solid state battery 10 having a high mechanical strength can be provided.

The glass transition temperature of the sealing material may be higher than the press temperature. The difference between the glass transition temperature of the sealing material and the press temperature is, for example, higher than or equal to 0° C. and lower than or equal to 20° C. When the glass transition temperature of the sealing material is higher than the press temperature, since no plastic deformation of the sealing material occurs by the press, the shape of the sealing layer 8 is maintained. Hence, in the all solid state battery 10 thus formed, since the sealing strength by the sealing layer 8 is sufficiently secured, an all solid state battery 10 having a high mechanical strength can be provided. As described above, when the press temperature is higher than the glass transition temperature of the binder and is lower than the glass transition temperature of the sealing material, while the warping of the electrode plate is suppressed, the sealing strength of the sealing layer 8 can be maintained. Accordingly, a mechanical strength of the all solid state battery 10 including the sealing layer 8 can be secured.

### EXAMPLES

Hereinafter, the present disclosure will be described in more detail with reference to Examples. The following Examples are described by way of example, and the present disclosure is not limited thereto.

### (Sample 1)

A solid electrolyte and a binder were mixed together, so that a mixture was obtained. The mixture was adhered to a collector by a coating process. Accordingly, an electrode plate including the collector and a solid electrolyte layer was obtained. As the binder, a styrene-ethylene-butylene-styrene-based thermoplastic elastomer (manufactured by Asahi Kasei Corporation, Tuftec M1913, glass transition temperature: 90° C.) was used. After the electrode plate thus formed was placed on a metal-made plate heated to 120° C. and then heated to a press temperature, press was performed at the press temperature. The press temperature was set to 120° C. Since the metal-made plate thus heated had a sufficient large thickness as compared to that of the electrode plate, and the difference in heat capacity therebetween was large, the temperature of the metal-made plate was regarded as the temperature of the electrode plate. In addition, the temperature of the metal-made plate was measured using a thermo couple disposed in the plate.

### (Sample 2)

Except for that the press temperature was set to 25° C. (room temperature), an electrode plate was obtained in a manner similar to that of Sample 1.

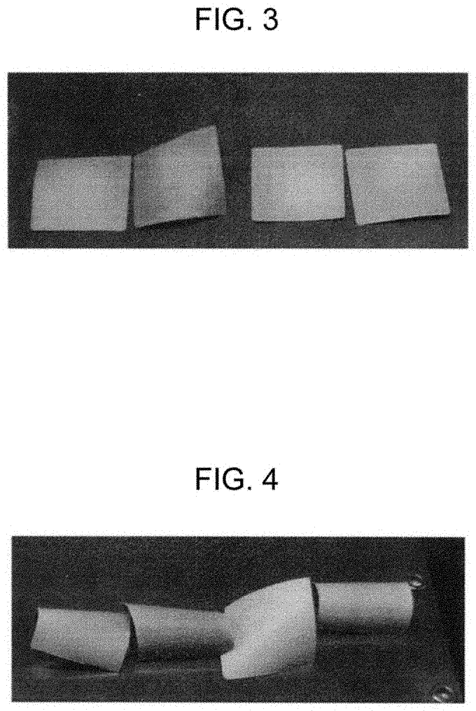

Photos of the electrode plates after the press are shown in FIGS. 3 and 4.

As shown in FIG. 3, in the electrode plate of Sample 1, a warping of the electrode plate after the press was suppressed. Since the press was performed at a temperature higher than the glass transition temperature of the binder, the warping of the electrode plate was suppressed.

On the other hand, as shown in FIG. 4, in the electrode plate of Sample 2, a large warping of the electrode plate was generated after the press. That is, since the press was performed at a temperature lower than the glass transition temperature of the binder, the warping of the electrode plate could not be suppressed.

The technique of the present disclosure is useful for batteries to be used in a personal digital assistant, a mobile electronic apparatus, a household electric power storage device, a motorcycle, an electric car, a hybrid electric car, and the like.

What is claimed is:

1. An all solid state battery comprising:
an electrode layer;
a solid electrolyte layer containing a solid electrolyte; and
a sealing layer containing a sealing material,
wherein at least one selected from the electrode layer and the solid electrolyte layer contains a binder,
a glass transition temperature of the sealing material is higher than a glass transition temperature of the binder,
the binder contains a thermoplastic resin, and
the thermoplastic resin includes at least one selected from a styrene-butadiene copolymer and a styrene-ethylene-butadiene copolymer.

2. The all solid state battery according to claim 1,
wherein the electrode layer and the solid electrolyte layer are laminated to each other, and
the sealing layer is in contact with at least one selected from a side surface of the electrode layer and a side surface of the solid electrolyte layer.

3. The all solid state battery according to claim 1,
wherein the glass transition temperature of the binder is less than 120° C.

4. The all solid state battery according to claim 1,
wherein the glass transition temperature of the sealing material is 120° C. or more.

5. The all solid state battery according to claim 1,
wherein the sealing material contains a polyimide.

6. The all solid state battery according to claim 1,
wherein the electrode layer contains an electrode active material and the solid electrolyte.

7. A method for manufacturing an all solid state battery, the method comprising:
heating at least one selected from an electrode layer and a solid electrolyte layer to a press temperature; and
pressing at least one selected from the electrode layer and the solid electrolyte layer at the press temperature,
wherein at least one selected from the electrode layer and the solid electrolyte layer to be pressed at the press temperature contains a binder,
the press temperature is higher than a glass transition temperature of the binder, and
the method further comprising:
forming a sealing layer so as to be in contact with at least one selected from the electrode layer and the solid electrolyte layer,
wherein when at least one selected from the electrode layer and the solid electrolyte layer is heated to the press temperature, the sealing layer is heated to the press temperature, and when at least one selected from the electrode layer and the solid electrolyte layer is pressed, the sealing layer is pressed at the press temperature.

8. The method for manufacturing an all solid state battery according to claim 7,
wherein the sealing layer is formed from a sealing material, and
the glass transition temperature of the sealing material is higher than a glass transition temperature of the binder.

9. The method for manufacturing an all solid state battery according to claim 8,
wherein the glass transition temperature of the sealing material forming the sealing layer is higher than the press temperature.
